(19) United States
(12) Patent Application Publication
(10) Pub. No.: US 2005/0168995 A1
(43) Pub. Date: Aug. 4, 2005

(54) Fresnel lens spotlight with coupled variation of the spacing of lighting elements

(75) Inventors: Rudiger Kittelmann, Einbeck (DE); Harry Wagener, Alfeld (DE)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Schott AG

(21) Appl. No.: 11/019,409

(22) Filed: Dec. 22, 2004

(30) Foreign Application Priority Data
Dec. 22, 2003 (DE) 103 61 117.7
Mar. 19, 2004 (DE) 10 2004 014 045.6

(51) Int. Cl. F21V 5/04

(52) U.S. Cl. 362/328; 362/335; 362/298

(57) ABSTRACT

A Fresnel lens spotlight whose emitted light beam has a variable aperture angle, having a reflector, a lamp and at least one Fresnel lens is provided. The at least one Fresnel lens has a negative focal length and a virtual focal point.

### DESCRIPTION

The invention relates to a Fresnel lens spotlight, whose emitted light beam has an adjustable aperture angle, having a reflector, a lamp and at least one Fresnel lens.

Those parts of conventional Fresnel lens spotlights which are relevant for lighting purposes generally comprise a lamp, a Fresnel lens and a spherical auxiliary reflector. The lamp filament is conventionally located essentially in a fixed position at the center of the sphere of the spherical reflector. In consequence, a portion of the light which is emitted from the lamp is reflected back into it, and assists the light emission in the front hemisphere. This light which is directed forwards is focused by the Fresnel lens. The degree of light focusing is, however, dependent on the distance between the Fresnel lens and the lamp. If the lamp filament is located at the focal point of the Fresnel lens, then this results in the narrowest light beam. This results in a quasi-parallel beam path, which is also referred to as a spot. The aperture angle of the emerging light beam is continuously enlarged by shortening the distance between the Fresnel lens and the lamp. This results in a divergent beam path, which is also referred to as a flood.

Spotlights such as these have the disadvantage, however, that the light yield is poor, particularly in their spot position, since in this case only a relatively small spatial angle range of the lamp is covered by the Fresnel lens. A further disadvantage is that a large proportion of the light which is reflected by the spherical reflector strikes the lamp filament itself again, where it is absorbed and additionally heats up the lamp filament.

DE 39 19 643 A1 discloses a spotlight having a reflector, a diaphragm and a Fresnel lens. The illumination produced by the spotlight is varied by moving the light source, which varies the brightness of the light. The brightness is regulated by regulating the distance between the apex and the reflector, and between the diaphragm and the reflector.

DE 34 13 310 A1 discloses a spotlight having a lamp and a reflector, or a lamp and a convergent lens. The spotlight also has a diffusing glass or a mirror, both of which are positioned at an angle of 45°. The mirror deflects the light, and the light is scattered by the diffusing glass. Different light beam emission angles are produced by moving the diffusing glass.

DE 101 13 385 C1 describes a Fresnel lens spotlight in which the Fresnel lens is a convergent lens whose focal point on the light source side is located approximately at the focal point of the ellipsoid reflector which is remote from the reflector when in the spot position. The distances between the focal points of the reflector, the focal length of the reflector and the focal length of the Fresnel lens thus add up to the minimum length of a Fresnel lens spotlight such as this.

However, the invention is intended to provide a Fresnel lens spotlight which has a more compact form and, in consequence, is more space-saving and also lighter than a conventional Fresnel lens spotlight.

This object is achieved in a surprisingly simple manner by a Fresnel lens spotlight as claimed in claim 1, and by a lighting set as claim in claim 19.

The use of a Fresnel lens with a negative focal length makes it possible to achieve an extremely compact form which, for example in the spot position of the Fresnel lens spotlight, now corresponds essentially only to the length of the reflector together with the thickness of the respectively used Fresnel lens.

The Fresnel lens spotlight according to the invention results in considerably better light efficiency, particularly in the spot position, but also in the flood position.

At the same time, the uniformity of the lighting intensity is maintained over the entire light field, as is illustrated, by way of example, from FIG. 7, both for the spot position and for a flood position.

According to the invention, an ellipsoid reflector with a large aperture is provided. The spot position is set such that the lamp filaments of a black body emitter, in particular of a halogen lamp, or the discharge arc of a discharge lamp is located at the focal point of the ellipsoid on the reflector side, and the second focal point of the ellipsoid, which is remote from the reflector, is arranged approximately at the negative or virtual focal point of the Fresnel lens which is remote from the reflector.

The light which is reflected by the reflector is focused virtually completely on the focal point of the ellipsoid which is remote from the reflector, before it enters the negative lens. The lamp filament which is located at the focal point on the reflector side, or the discharge arc, is imaged at infinity after passing through the Fresnel lens, and its light is thus changed to a virtually parallel beam.

The reflected light essentially no longer strikes the lamp filament or the discharge arc. The virtual negative focal point of the Fresnel lens coincides with the focal point of the reflector ellipsoid which is remote from the reflector, and thus results in an extremely compact form.

If the aperture angle of the reflector and of the Fresnel lens is chosen expediently, the light which is reflected by the reflector virtually all passes through the Fresnel lens and is emitted forwards as a narrow spot beam.

The light yield is thus considerably greater than in the case of a conventional Fresnel lens spotlight.

The aperture angle of the light beam which emerges from the Fresnel lens can be enlarged virtually indefinitely in a first embodiment by varying the lamp position with respect to the reflector on the one hand, and by varying the distance between the Fresnel lens and the reflector on the other hand, in a suitable manner.

In order to retain the good characteristics of conventional Fresnel lens spotlights with respect to the uniformity of the illumination intensity, these distance changes should be carried out by means of expediently chosen positive coupling.

One embodiment of the invention comprises the ellipsoid reflector being composed of a metallic or transparent material. Glass and polymer materials or plastics are preferably used, which may advantageously be coated with metal, for example aluminum.

Alternatively or additionally in order to produce a reflective surface, one of the two or both surfaces of the reflector is or are provided with a system of optically thin layers. In consequence, visible radiation components are advantageously reflected, and the invisible components, in particular thermal radiation components, are passed through.

A further preferred embodiment of the invention comprises a metallic coating on one or both main surfaces of the reflector.

In a further alternative refinement, the reflector may also be a metallic reflector which may either be uncoated or else may be dielectrically or metallically coated, in order to produce the desired spectral and corrosion characteristics.

One preferred embodiment of the invention comprises a Fresnel lens spotlight in which the light-reflective surface of the reflector is structured such that it scatters light, and none, one or two surfaces of the Fresnel lens is or are structured such that it or they scatter light. This results in a fixed proportion of the superimposition of scattered light with respect to geometrically/optically imaged light, which avoids the lamp being imaged in the light field. The reflector for this purpose preferably has surface elements or facets which allow its light-scattering components to be calculated and to be manufactured in a defined manner.

With increasing miniaturization of the light source, for example in the important field of digital projection or in the case of high-power discharge lamps, it is, however, possible for an ever more strongly pronounced central dark area to occur, which cannot be compensated for, or can be compensated for only with major light losses, by means of scattering devices within the reflector. The conventional scattering devices which are used to avoid imaging of the emission center of the light source overcome this only to a limited extent, if at all, since in this case as well at least the dark central opening sphere must be illuminated homogeneously in every position of the Fresnel lens spotlight. However, particularly in the spot position, this results in excessive light losses since only a dark area with a very small aperture angle is present here but, nevertheless, the complete area of the Fresnel lens is used to scatter the light field in conventional Fresnel lenses with scattering devices.

The inventors have found that these high light losses can be avoided in a surprisingly simple manner. In this case, it is particularly advantageous for the Fresnel lens to have a diffusing glass which, in a particularly preferred manner, is circular and is now just arranged at the center of the Fresnel lens.

In this embodiment the dark areas in the center of the illuminated field can be avoided very effectively in every position of the Fresnel lens spotlight, without this leading to major light losses while the reflector is in the spot position.

Surprisingly, it has been found that the geometrical/optical beam path of the light which emerges from the reflector illuminates a smaller area at the position of the Fresnel lens precisely when the required proportion of scattered light is increased.

The inventors have made use of this effect in order, by means of the invention, to create an automatic or adaptive light mixing system which, in synchronism with the movement of the Fresnel lens spotlight, mixes with the geometrically/optically imaged light only that scattered light component which is required for this position.

This lighting mixture ratio, which can be virtually optimally matched to the respectively required light distributions, is referred to only as the mixing ratio in the following text, for short.

This automatic light mixing system results in the correct mixing ratio essentially for every position of the reflector, a very homogeneously illuminated light field thus always being created, without unnecessary scattering losses occurring, however, at the same time.

In this case, the mixing ratio of the completely illuminated Fresnel lens can be defined by the choice of the diameter of the integrated diffusing glass with respect to the remaining area of the Fresnel lens, and the aperture angle of the scattered light can be defined by the scattering characteristics of the negative lens.

Furthermore, the scattering effect on the integrating diffusing glass itself may vary so that, for example, more strongly scattering areas are arranged in the center of the diffusing glass and less strongly scattering areas are arranged at its edge. In consequence, a relatively highly focused beam is additionally also widened, and extremely wide illumination angles can then be achieved.

Alternatively, the edge of the diffusing glass may also not only end abruptly but may be designed such that its scattering effect decreases continuously, and may also extend under or above the Fresnel lens. This allows further adaptations to the position-dependent mixing ratios.

Reference is made to the application, submitted on the same date, by the same applicant entitled “Optische Anordnung mit Stufenlinse” [Optical Arrangement with a Fresnel lens], whose disclosure content is also included completely, by reference, in the disclosure content of the present application.

According to the invention, the spotlight is intended to be used for architecture, medicine, film, stage, studio and photography as well as in a flashlight.

The diffusing glass in the preferred embodiments may be arranged either on the light inlet side or on the light outlet side. Furthermore, it is advantageously possible to arrange diffusing glasses at the light inlet or on the light outlet side. In this last-mentioned embodiment, it is also possible to use diffusing glasses with different scatter, for example diffusing glasses which scatter differently in different positions.

The invention will be described in more detail using preferred embodiments and with reference to the attached drawings, in which:

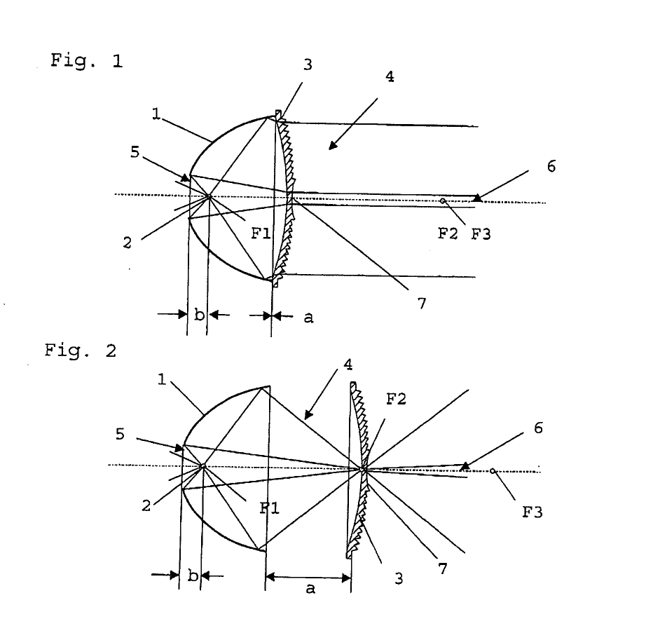

FIG. 1 shows an embodiment of the Fresnel lens spotlight in the spot position, with the focal point of the reflector which is remote from the reflector being approximately superimposed on the virtual focal point of the Fresnel lens on the right-hand side,

FIG. 2 shows the embodiment of the Fresnel lens spotlight as shown in FIG. 1 in a first flood position, with the focal point of the reflector which is remote from the reflector being arranged approximately on a surface of the Fresnel lens which is close to the reflector,

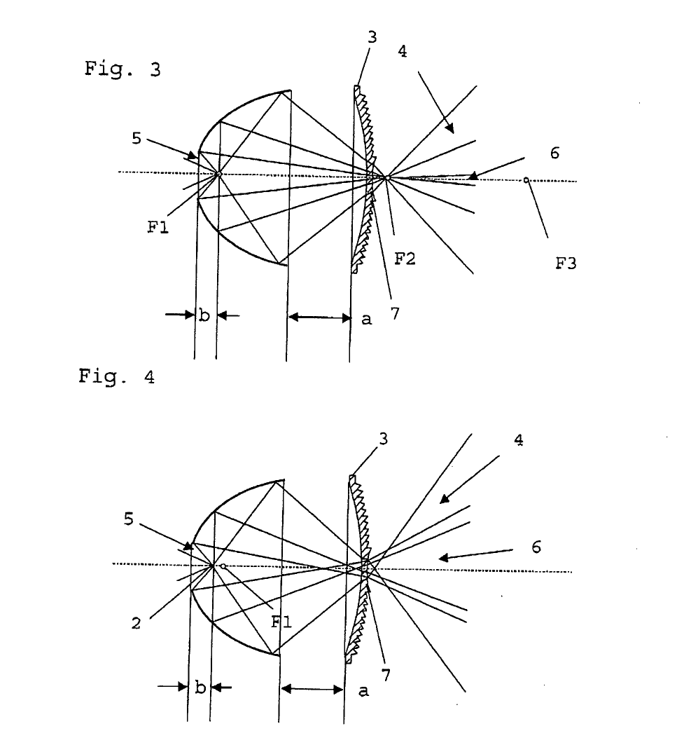

FIG. 3 shows the embodiment of the Fresnel lens spotlight as shown in FIG. 1 in a second flood position with a larger aperture angle, with the focal point of the reflector which is remote from the reflector being imaged by the Fresnel lens in front of that surface of the Fresnel lens which is remote from the reflector,

FIG. 4 shows the embodiment of the Fresnel lens spotlight as illustrated in FIG. 1 in a third flood position with an even larger aperture handle than in the second flood position, with the focal point of the reflector which is remote from the reflector being imaged by the Fresnel lens in front of that surface of the Fresnel lens which is remote from the reflector, and with the light source being moved toward the reflector, from the focal point which is close to the reflector,

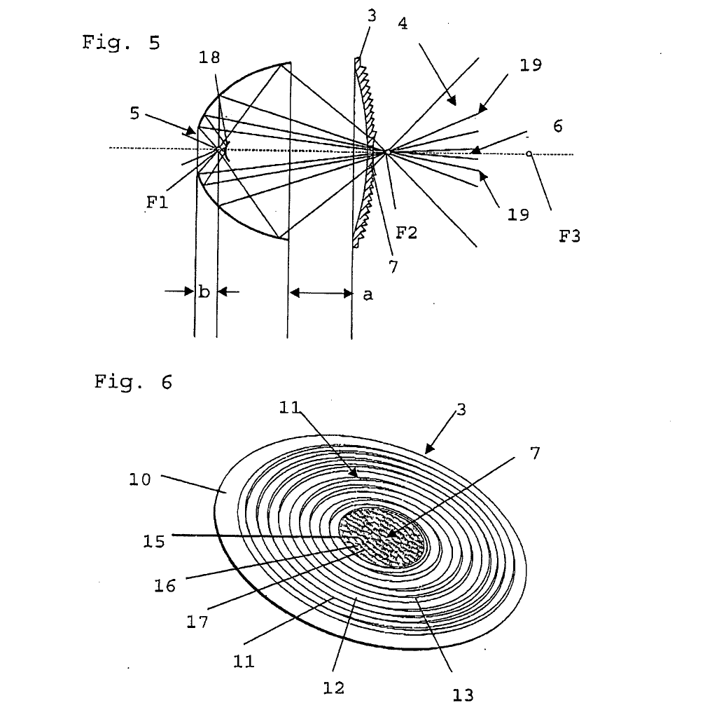

FIG. 5 shows the embodiment of the Fresnel lens spotlight as shown in FIG. 1 in its second flood position with a larger aperture angle, with a further portion of the light initially being passed by means of an auxiliary reflector into the reflector and from there into the Fresnel lens,

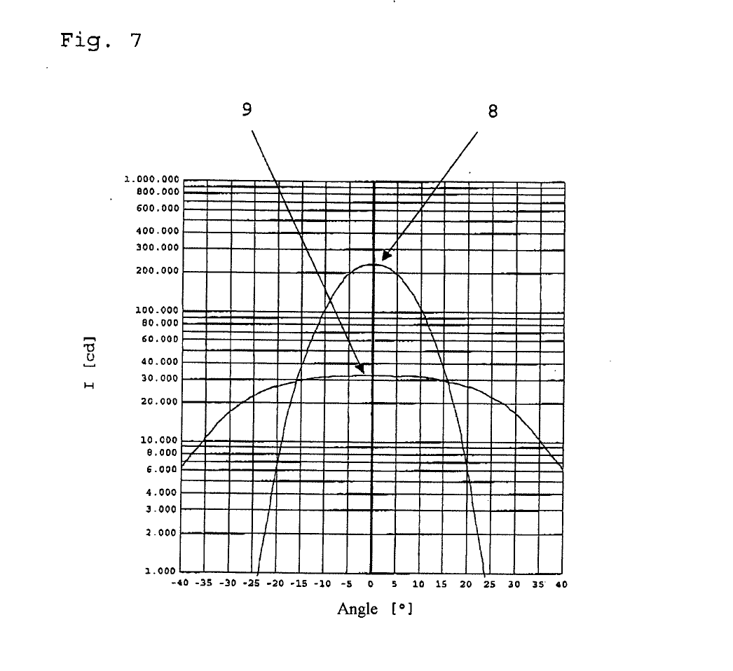

FIG. 6 shows a negative Fresnel lens with a centrally arranged diffusing glass,

FIG. 7 shows a logarithmic representation (which is dependent on the aperture angle) of the light intensity of the Fresnel lens spotlight in its spot position and in one of its flood positions.

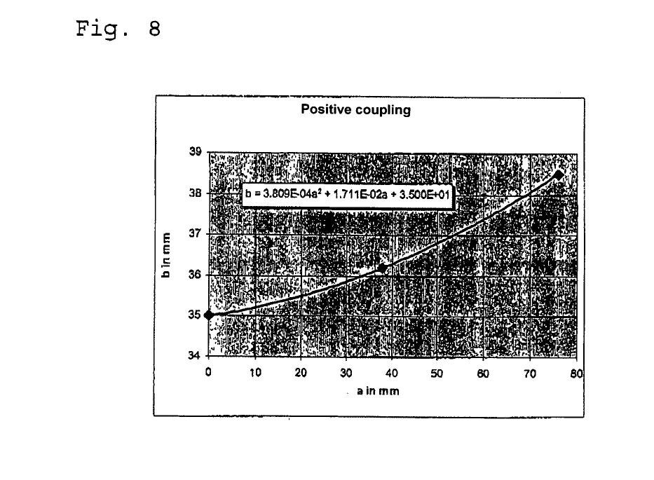

FIG. 8 shows a characteristic for the positive coupling between the variables a and b, with the parameters for the Fresnel lens, for the elliptical reflector and for the luminaire being chosen by way of example.

### DETAILED DESCRIPTION OF PREFERRED EMBODIMENTS

In the following detailed description, the same reference symbols are used to denote the same elements or elements having the same effect in each of the various embodiments.

The following text refers to FIG. 1, which shows one embodiment of the Fresnel lens spotlight in the spot position. The Fresnel lens spotlight essentially contains an ellipsoid reflector 1, a lamp 2 which may be a halogen lamp or else a discharge lamp, and a Fresnel lens 3, which is a lens with negative refractive power, preferably a biconcave Fresnel lens.

In FIG. 1, the focal point F2 of the ellipsoid reflector 1 which is remote from the reflector is approximately superimposed on the virtual or negative focal point F3 of the Fresnel lens 3 on the right-hand side.

The light beam 4 which is emitted from the spotlight is indicated only schematically in the figures by its outer edge beams.

The distances a between the Fresnel lens 3 and the front edge of the reflector 1, and b between the lamp 2 and the apex of the reflector 1, are likewise shown in FIG. 1.

The spot position is set by arranging the lamp filament or the discharge arc of the lamp 2 essentially at the focal point F1 of the reflector ellipsoid 1 on the reflector side.

The light which is reflected by the reflector 1 is, in this position, directed virtually completely at the focal point F2 of the ellipsoid 1 which is remote from the reflector. The right-hand side negative or virtual focal point F3 of the Fresnel lens 3 then coincides approximately with the focal point F2 of the reflector ellipsoid 1.

The near field in FIG. 1 also shows how the opening 5 within the reflector 1 acts as a dark area 6 in the parallel beam path of the light field 4.

A circular, centrally arranged diffusing glass 7 is provided within the Fresnel lens 3, and produces a defined scattered light ratio and a defined aperture angle of the scattered light. This results in a defined mixing ratio of the scattered light relative to the light which is geometrically/optically imaged by the Fresnel lens 3.

As alternative to this embodiment of the diffusing glass 7, the scattering effect in a further embodiment changes along the radius of the diffusing glass 7 continuously, such that more strongly scattering areas are arranged at the center of the diffusing glass 7, and less strongly scattering areas are arranged at its edge, which ends abruptly.

In yet another alternative refinement, the edge of the diffusing glass 7 is not only designed such that it ends abruptly, but is also designed such that its scattering effect decreases continuously, and this may also extend under or above the Fresnel lens.

In consequence, further adaptations to the position-dependent mixing ratios are carried out as a function of the system, so that a person skilled in the art can always provide an optimum mixing ratio for a homogeneously illuminated light field or else for light fields with locally higher intensities which are produced in a defined manner.

FIG. 1 also shows that only a small proportion of the total light passes through the diffusing glass 7 in the spot position.

The diffusing glass 7 results in very homogeneous illumination, as is shown by the line 8 for the spot position in FIG. 7, which shows a logarithmic representation (which is dependent on the aperture angle) of the light intensity of the Fresnel lens spotlight.

FIG. 2 shows the embodiment of the Fresnel lens spotlight as illustrated in FIG. 1 in a first flood position, in which the focal point F2 of the reflector 1 which is remote from the reflector is arranged approximately on a surface of the Fresnel lens 3 which is close to the reflector.

In this case, the value of the shift a with respect to the spot position is changed in a defined manner by means of a mechanical guide.

Fundamentally, the design corresponds to the design of the Fresnel lens spotlight explained in FIG. 1.

However, as can clearly be seen from FIG. 2, both the aperture angle of the emitted light beam 4 and that of the dark area 6 have increased.

However, since a very large proportion of the light in this position strikes only a very small area in the center of the diffusing glass 7, this area can in fact be designed such that its forward scattering lobe compensates approximately for the dark area 6 in the far field or far area in a desired manner. Reference should also be made to FIG. 7, which shows the light conditions with the line 9, for example for a flood position.

The foreign text refers to FIG. 3, which shows the embodiment illustrated in FIG. 1 of the Fresnel lens spotlight in a second flood position with an even larger aperture angle than in FIG. 2, with the focal point F2 of the reflector 1 which is remote from the reflector being imaged by the Fresnel lens 3 in front of that surface of the Fresnel lens 3 which is remote from the reflector.

In this case, a larger area of the diffusing glass 7 has light passing through it than shown in FIG. 2, and its overall scattering behavior can be matched to the relationships of this flood position.

As is illustrated in FIG. 4, the beam 4 is widened further, as an alternative to or in addition to the flood position shown in FIG. 3, by varying the distance b between the lamp 2 and the reflector 1. Moving the lamp 2 towards the reflector 1 once again focuses the light beam leaving the reflector more strongly, leading to increased emission angles after emerging from the Fresnel lens 3.

The change in the distance a and in the distance b may in further embodiments be carried out, for example, by hand, mechanically, electrically, electronically or in combination with one another, in which case the optical components may be guided axially for this purpose.

In order to retain the uniformity of the illumination intensity, the distance changes in one particularly preferred embodiment are, however, carried out by means of expediently chosen positive coupling, which maintains a defined relationship between the change in a and b.

The relationship between the variables a and b that is defined by means of the positive coupling is governed by the parameters used for the Fresnel lens, for the integrated diffusing glass, for the elliptical reflector and for the luminaire. The parameters in this case include the dimensions, the geometry, the structure and the optical characteristics of the individual components.

In particular, the parameters used for the Fresnel lens include its optical diameter, its focal length, its curvature, its light-scattering structure and its arrangement on the front and/or rear face of the Fresnel lens; the parameters for the diffusing glass which is integrated in the Fresnel lens are its optical diameter, its light-scattering structure and its arrangement; the parameters for the elliptical reflector are its optical diameter, its curvature, its focal length, its surface structure, the distance between the two focal points and the diameter of the lamp bushing, and the parameters for the luminaire are its shape, its dimensions, its position and the nature of the luminaire, for example in the form of a metal vapor discharge lamp, halogen lamp or CDM lamp. Parameters which are not mentioned expressly here may result in further influences.

As an example, FIG. 8 shows a characteristic for the positive coupling between the variables a and b. The parameters used for the Fresnel lens, for the elliptical reflector and for the luminaire are chosen, for example, as follows:
Fresnel lens: with an optical diameter of 160 mm and a negative focal length of 108.7 mm, an integrated diffusing glass with a diameter of 28 mm at the center (honeycomb: diagonal 3.4 mm, radius 4 mm, 30 twist), rear face with a light-scattering structure;
elliptical reflector: with an optical diameter of 160 mm and a focal length of 35 mm, a distance of 160 mm between the two focal points, lamp guide with a diameter of 30 mm;
luminaire: a cylinder in the axial position, approximately 7.2 mm long, diameter approximately 2.6 mm.

A change in the parameters leads to a change in the relationship between the variables a and b defined by means of the positive coupling. This results in a change in the functional relationship for the characteristic defining the positive coupling.

FIG. 5 shows a further preferred embodiment. In this embodiment, which corresponds essentially to the embodiments described above except for having an additional auxiliary reflector 18, the auxiliary reflector 18 deflects the light from the lamp 2 (which would propagate to the right in FIG. 5 and would no longer reach the reflector 1) into the reflector 1 by reflection. In consequence, not only can the light which is represented merely by way of example by the beam path 19 and which would not contribute to the illumination without the auxiliary reflector be used, but it is also possible to use that portion of the light which otherwise enters the Fresnel lens 3 directly better for the desired light distribution.

The shape of the auxiliary reflector 18 is advantageously chosen such that light which is reflected on it does not enter the means of producing light in the lamp 2 again, for example a filament or a discharge zone, and does not unnecessarily heat it as well.

Alternatively, the auxiliary reflector 18 may be fitted to the inner face and/or outer face of the glass body of the lamp 2. The glass of the lamp body may be appropriately shaped for this purpose, in order to achieve the desired directional effect for the reflected light.

By way of example, FIG. 6 shows a Fresnel lens 3 with a diffusing glass 7, as is used by the invention. The Fresnel lens 3 has a transparent base body 10 as well as a Fresnel lens ring system 11 with annular lens sections 11, 12, 13, between which the circular diffusing glass 7 is arranged.

The diffusing glass 7 is structured in a defined manner or has facets 15, 16, 17 with a scattering behavior which can be defined exactly within wide limits, which facets 15, 16, 17 are described in German Patent Application DE 103 43 630.8 from the same applicant entitled “Streuscheibe” [Diffusing glass], which was submitted to the German Patent and Trademarks Office on September 19. The disclosure content of this application is also in its entirety included by reference in the disclosure content of this application.

However, the invention is not restricted to these already described embodiments of diffusing glasses.

The Fresnel lens spotlight described above is particularly advantageously used in a lighting set together with an electrical power supply unit or ballast, which is considerably smaller than in the case of the prior art. This power supply unit can be designed both electrically and mechanically to be smaller for the same usable light power than in the case of the prior art, since the Fresnel lens spotlight according to the invention has a considerably higher light yield. Less weight is therefore required, and a smaller storage space is occupied for transportation and storage.

However, particularly when using cold light reflectors, this also reduces the total thermal load on illuminated people and objects.

Furthermore, the Fresnel lens spotlight according to the invention can advantageously also be used to increase the light yield from flashlights in which, in principle, the available electrical energy is more severely limited.

List of Reference Symbols

1 Reflector
2 Lamp
3 Fresnel lens
4 Emitted light beam
5 Opening in the reflector 1
6 Dark area
7 Diffusing glass
8 Intensity distribution in the spot position
9 Intensity distribution in the flood position
10 Base body
11 Fresnel lens ring system
12 Annular lens sections
13 Ditto
14 Ditto
15 Facet
16 Ditto
17 Ditto
18 Auxiliary reflector
19 Beam path reflected by the auxiliary reflector

1. A Fresnel lens spotlight having an emitted light beam with an adjustable aperture angle, comprising:
a reflector,
a lamp; and
at least one Fresnel lens having a negative focal length that defines a virtual focal point.

2. The Fresnel lens spotlight as claimed in claim 1, wherein the reflector has a reflector focal point that is remote from the reflector so that the reflector focal point can be superimposed on the virtual focal point in the spot position of the Fresnel lens spotlight.

3. The Fresnel lens spotlight as claimed in claim 1, wherein the at least one Fresnel lens is a biconcave negative lens.

4. The Fresnel lens spotlight as claimed in claim 1, wherein the at least one Fresnel lens comprises a double lens with chromatically corrected imaging characteristics.

5. The Fresnel lens spotlight as claimed in claim 1, wherein the at least one Fresnel lens comprises an integrated diffusing glass.

6. The Fresnel lens spotlight as claimed in claim 5, wherein the integrated diffusing glass is circular and is arranged at the center of the at least one Fresnel lens.

7. A Fresnel lens spotlight having an emitted light beam with an adjustable aperture angle, comprising:
a reflector;
a lamp;
a Fresnel lens having a negative focal length that defines a virtual focal point; and
a first distance being defined between the Fresnel lens and the reflector, said first distance being variable in a defined geometric relationship with respect to a second distance defined between the lamp and the reflector on the basis of the adjustable aperture angle to be for the emitted light beam.

8. The Fresnel lens spotlight as claimed in claim 7, wherein the second distance can be adjusted by arranging the lamp so that it can be moved with respect to an apex of the reflector.

9. The Fresnel lens spotlight as claimed in claim 7, wherein the reflector comprises a metallic or transparent dielectric glass and/or plastic.

10. The Fresnel lens spotlight as claimed in claim 7, wherein the reflector comprises at least one surface having a system of optically thin layers.

11. The Fresnel lens spotlight as claimed claim 7, wherein the reflector comprises a surface coated with aluminum.

12. The Fresnel lens spotlight as claimed in claim 7, wherein the reflector is structured to scatter light and/or the at least one Fresnel lens is structured to scatter light.

13. (canceled)

14. The Fresnel lens spotlight as claimed in claim 7, wherein the reflector and/or the at least one Fresnel lens are/is coated on at least one side.

15. The Fresnel lens spotlight as claimed in claim 14, wherein the coating on the at least one Fresnel lens is a dielectric interference layer system that changes the spectrum of the light passing through it.

16. The Fresnel lens spotlight as claimed in claim 7, wherein the lamp is selected from the group consisting of a halogen lamp, a light-emitting diode, a light-emitting diode array, and a gas discharge lamp.

17. The Fresnel lens spotlight as claimed in claim 7, further comprising an auxiliary reflector arranged between the at least one Fresnel lens and the reflector.

18. The Fresnel lens spotlight as claimed in claim 7, wherein the at least one Fresnel lens is thermally prestressed, on its surface.

19. A lighting set having an emitted light beam with an adjustable aperture angle, comprising:
a reflector;
a lamp;
a Fresnel lens having a negative focal length that defines a virtual focal point;
a first distance being defined between the Fresnel lens and the reflector, said first distance being variable in a defined geometric relationship with respect to a second distance defined between the lamp and the reflector on the basis of the adjustable aperture angle for the emitted light beam; and
an associated electrical power supply unit or ballast.

20. (canceled)

21. A flashlight having an emitted light beam with an adjustable aperture angle, comprising:
a reflector;
a lamp;
a Fresnel lens having a negative focal length that defines a virtual focal point;
a first distance being defined between the Fresnel lens and the reflector, said first distance being variable in a defined geometric relationship with respect to a second distance defined between the lamp and the reflector on the basis of the adjustable aperture angle for the emitted light beam; and
an electrical energy source.

22. The Fresnel lens spotlight as claimed in claim 7, wherein the reflector has a reflector focal point that is remote from the reflector so that the reflector focal point can be superimposed on the virtual focal point in the spot position of the Fresnel lens spotlight.

23. The Fresnel lens spotlight as claimed in claim 7, wherein the Fresnel lens is a biconcave negative lens.

24. The Fresnel lens spotlight as claimed in claim 7, wherein the Fresnel lens comprises a double lens with chromatically corrected imaging characteristics.

25. The Fresnel lens spotlight as claimed in claim 7, wherein the Fresnel lens comprises an integrated diffusing glass.

26. The Fresnel lens spotlight as claimed in claim 25, wherein the integrated diffusing glass is circular and is arranged at the center of the Fresnel lens.

27. The Fresnel lens spotlight as claimed in claim 26, wherein the integrated diffusing glass defines a light mixing system that changes a proportion of scattered light relative to a proportion of optically imaged light as a function of the position of the Fresnel lens spotlight.

28. The lighting set as claimed in claim 19, wherein the reflector has a reflector focal point that is remote from the reflector so that the reflector focal point can be superimposed on the virtual focal point in the spot position of the lighting set.

29. The flashlight as claimed in claim 21, wherein the ellipsoid reflector has a reflector focal point that is remote from the ellipsoid reflector so that the reflector focal point can be superimposed on the virtual focal point in the spot position of the flashlight.
